(19) United States
(12) Patent Application Publication
(10) Pub. No.: US 2026/0257266 A1
(43) Pub. Date: Sep. 3, 2026

(54) METHOD AND APPARATUS FOR APPLYING CHAPLETS ON CERAMIC CORES IN THE MANUFACTURE OF AIRFOILS

(71) Applicant: PCC Airfoils, LLC, Beachwood, OH (US)

(72) Inventors: Andrew CROSS, Beachwood, OH (US); Brent POLEN, Beachwood, OH (US)

(73) Assignee: PCC Airfoils, LLC, Beachwood, OH (US)

(21) Appl. No.: 19/551,662

(22) Filed: Feb. 27, 2026

Related U.S. Application Data
(60) Provisional application No. 63/764,993, filed on Feb. 28, 2025.

(51) Int. Cl. B22C 9/10; B05D 1/26; B05D 3/06; B25J 11/00

(52) U.S. Cl. CPC B22C 9/10; B05D 1/26; B05D 3/067; B05D 2203/30; B25J 11/0075

(57) ABSTRACT

A method of preparing a ceramic core for wax injection in an investment casting process includes: (a) applying a predetermined amount of material to the ceramic core in a predetermined location with a machine applicator; (b) securing the predetermined amount of material to the ceramic core to form a chaplet; and (c) repeating steps (a) and (b) to form a plurality of chaplets on the ceramic core.

### CROSS-REFERENCE TO RELATED APPLICATIONS

This application claims priority to and the benefit of U.S. Provisional Application 63/764,993 filed on Feb. 28, 2025. The disclosure of the above application is incorporated herein by reference.

### FIELD

The present disclosure relates to investment casting of airfoils using ceramic cores, and more specifically to methods and systems for preparing the ceramic cores.

### BACKGROUND

The statements in this section merely provide background information related to the present disclosure and may not constitute prior art.

Manufacturing of airfoils for use in turbine applications, such as by way of example turbine engines for aircraft, typically involves the investment casting process. In the investment casting process, also known as the lost wax process, a ceramic core is created from a mold, which is then placed inside another mold for the injection of wax in an around the ceramic core. The ceramic core generally defines the interior geometry of the finished airfoil, which includes a variety of openings such as cooling channels/passageways. After the wax is formed around the ceramic core, a plurality of ceramic cores with wax are joined together in a cluster, which are then dipped into a slurry, often referred to as a slip, then covered with sand. The entire cluster is then heated under pressure to remove the wax, which forms an empty space into which molten metal is poured, i.e., the lost wax casting process. Once the metal cools, the outer shell is removed, typically by a vibration process, and the inner ceramic core is removed, typically in a soda bath. The resulting product is thus the metal airfoil.

During the wax injection process, a distance between an exterior surface of the ceramic core and an interior surface of the wax mold is maintained to relatively tight tolerances in order to maintain the final geometry of the metal airfoil. However, existing methods to maintain this distance are tedious and involve extensive manual labor, which increases manufacturing time and cost and inherently includes higher process variation. More specifically, the ceramic core could break and increase an amount of scrap, reducing process yield.

These issues related to the preparation of ceramic cores for investment casting are addressed by the present disclosure.

### SUMMARY

This section provides a general summary of the disclosure and is not a comprehensive disclosure of its full scope or all of its features.

In one form, a method of preparing a ceramic core for wax injection in an investment casting process comprises: (a) applying a predetermined amount of material to the ceramic core in a predetermined location with a machine applicator; (b) securing the predetermined amount of material to the ceramic core to form a chaplet; and (c) repeating steps (a) and (b) to form a plurality of chaplets on the ceramic core.

In variations of this method, which may be implemented individually or in any combination: the machine applicator includes a microdispenser and the predetermined amount of material is a polymeric resin; the securing comprises curing the polymeric resin; the polymeric resin is cured by ultraviolet (UV) light; the microdispenser applies the polymeric resin to the ceramic core in a direction normal to an exterior surface of the ceramic core at the predetermined location; the ceramic core is picked by a robotic end effector and moved to a three-dimensional (3D) location for the applying in step (a); the ceramic core is repositioned to a different 3D location by the robotic end effector after step (a) and for the securing in step (b); the robotic end effector repositions the ceramic core to another different 3D location for another applying in step (a); the 3D location of the ceramic core is verified with a vision system; a position of at least one of the chaplets on the ceramic core after step (b) is verified with a vision system; the predetermined amount of material is a preformed chaplet and the machine applicator includes a robotic end effector that picks the preformed chaplet and moves the preformed chaplet to the predetermined location; the preformed chaplet is a molded polymer; the preformed chaplet is color coded as a function of its size; and a predetermined amount of adhesive is applied to the ceramic core before the robotic end effector moves the preformed chaplet to the predetermined location.

In another form of the present disclosure, a system for preparing a ceramic core for wax injection in an investment casting process comprises a robotic end effector configured to pick a ceramic core and move the ceramic core to a plurality of predetermined three-dimensional (3D) locations. A machine applicator is configured to apply a predetermined amount of material to the ceramic core in predetermined locations, and a securing station is configured to secure the predetermined amount of material to the ceramic core. A controller includes a processor and a nontransitory computer-readable medium, including instructions that are executable by the processor, wherein the instructions include: where and when to move the robotic end effector; when to activate the machine applicator; and when to activate the securing station.

In variations of this system, which may be implemented individually or in any combination: a vision system is configured to verify at least one of the plurality of predetermined three-dimensional (3D) locations of the ceramic core or the predetermined locations of the predetermined amount of material, wherein the vision system is in communication with the controller to effect the instructions; the machine applicator includes a microdispenser, and the predetermined amount of material is a polymeric resin; the securing station is an ultraviolet (UV) light source that cures the polymeric resin; the microdispenser and the UV light source are integrated onto a single mount; the machine applicator is a robotic end effector that picks a preformed chaplet and moves the preformed chaplet to one of the predetermined locations; and the securing station is an adhesive applied to the ceramic core by an adhesive applicator at the predetermined locations, wherein the robotic end effector places the preformed chaplet onto the adhesive.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a core assembly including a ceramic core and a plurality of chaplets constructed according to the teachings of the present disclosure;

FIG. 2 is a flowchart illustrating a general method of preparing a ceramic core for wax injection in an investment casting process according to the teachings of the present disclosure;

FIG. 3 is a diagram illustrating a system for preparing a ceramic core for wax injection in an investment casting process according to the teachings of the present disclosure;

FIG. 4 is an enlarged perspective view of a chaplet being applied to a ceramic core according to the teachings of the present disclosure;

FIG. 5 is a perspective view illustrating a ceramic core positioned under a machine applicator according to the teachings of the present disclosure;

FIG. 6 is a perspective view illustrating a predetermined amount of material being applied to a ceramic core according to the teachings of the present disclosure;

FIG. 7 is a perspective view illustrating a ceramic core positioned at a securing station according to the teachings of the present disclosure;

FIG. 8 is a perspective view illustrating the predetermined amount of material being cured to form a chaplet according to the teachings of the present disclosure;

FIG. 9 is another perspective view illustrating the ceramic core being repositioned to form another chaplet on the ceramic core according to the teachings of the present disclosure;

FIG. 10 is a flowchart illustrating a method of preparing a ceramic core for wax injection in an investment casting process as illustrated in FIGS. 5 to 9, according to the teachings of the present disclosure;

FIG. 11 is a schematic view of a variant of a system for preparing a ceramic core for wax injection in an investment casting process according to the teachings of the present disclosure; and

FIG. 12 is a flowchart illustrating another method of preparing a ceramic core for wax injection in an investment casting process according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

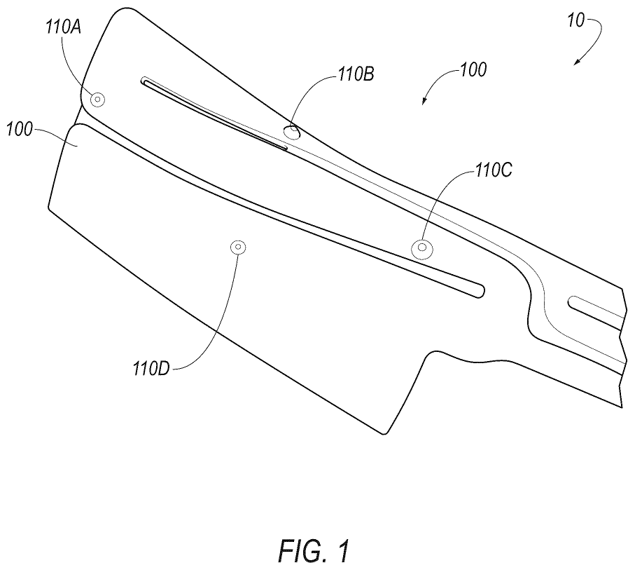

Referring to FIG. 1, a core assembly 10 for use in an investment casting process for forming high performance airfoils (e.g., for use in turbine engines) is shown. The core assembly 10 includes a ceramic core 100 and a plurality of chaplets 110 formed on the ceramic core 100. As a part of a process of preparing the ceramic core 100 for wax injection, the plurality of chaplets 110 are disposed on the ceramic core 100 in predetermined locations, for example, as shown by chaplets 110A-110D. It should be understood that the number and location of the chaplets 110 is merely exemplary, and thus a fewer or greater number of chaplets 110 may be employed, and in different predetermined locations, while remaining within the scope of the present disclosure. The plurality of chaplets 110 may have the same or different sizes depending on the particular ceramic core 100 design and application. The chaplets 110 are generally provided to maintain a wall thickness of the ceramic core 100 within a die during wax injection and are melted during the investing process. In one form, the chaplets 110 have a height of between 0.020 and 0.100 inches and are generally hemispherical in their geometric shape, which is illustrated in greater detail below.

The present disclosure provides a novel method of preparing the ceramic core 100, and more specifically constructing/applying, locating, and inspecting the chaplets 110 on the ceramic core 100 to form a core assembly 10 using machine automation.

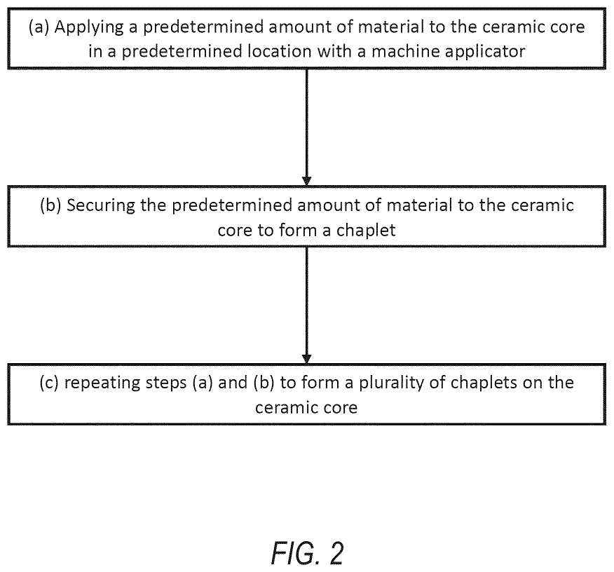

Referring to FIG. 2, a general method of applying the chaplets 110 to the ceramic core 100 is shown. Broadly, as will be discussed in greater detail below, the method includes: (a) applying a predetermined amount of material to the ceramic core 100 in a predetermined location with a machine applicator; (b) securing the predetermined amount of material to the ceramic core 100 to form a chaplet 110 on the ceramic core 100; and (c) repeating steps (a) and (b) to form the plurality of chaplets 110 on the ceramic core 100 in the various predetermined locations to form the core assembly 10.

### Polymeric Resin/Cure Method #1

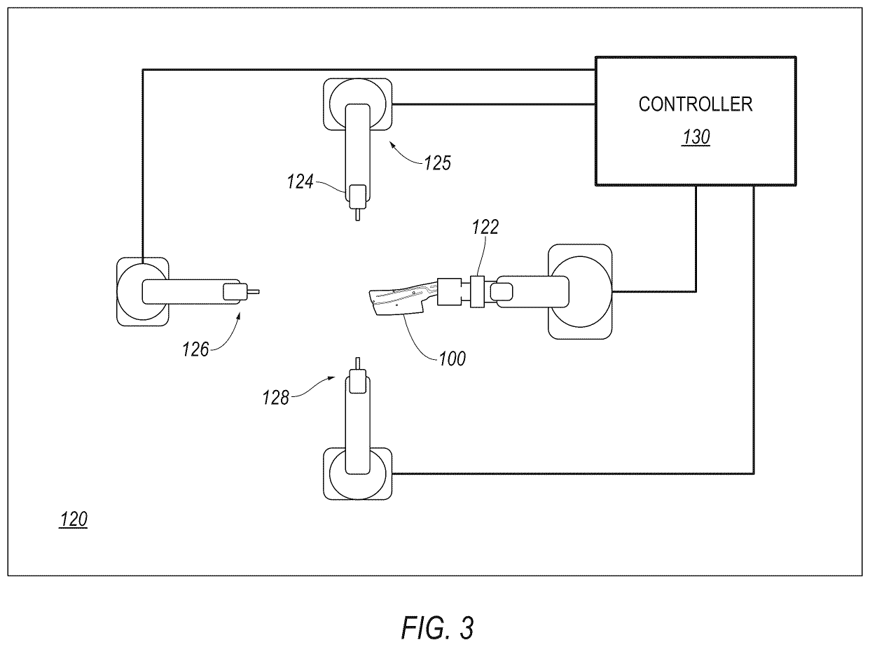

Referring to FIG. 3, a method according to the teachings of the present disclosure in one form is performed by a system 120 including a robotic end effector 122, a machine applicator 124 located at an application station 125, a securing station 126, an optional vision system 128, and a controller 130. The robotic end effector 122 generally grasps and moves the ceramic core 100 between the machine applicator 124, the securing station 126, and the vision system 128, and is controlled by the controller 130. The robotic end effector 122 also moves and repositions the ceramic core 100 for the application of multiple chaplets 110 at the application station 125. The controller 130 activates each of the robotic end effector 122, the machine applicator 124, the securing station 126, and the vision system 128 based on the position of the robotic end effector 122. In one form, the controller 130 is a non-transitory computer-readable medium including instructions that are executable by the processor such as: where (i.e., 3-dimensional (3D) position in space), how (i.e., geometric path, rate of movement (e.g., ft/sec)), and when to move the robotic end effector 122; when to activate the machine applicator 124; when to activate the securing station 126; when to activate the vision system 128; amount of material to be dispensed; and curing time. It should be understood that these instructions/process parameters are merely exemplary and are not to be construed as limiting the scope of the present disclosure.

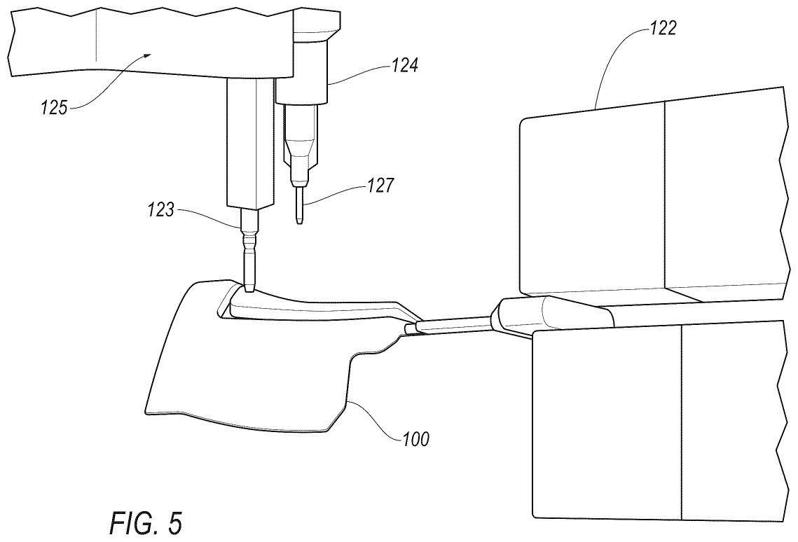

In this form, the machine applicator 124 includes a microdispenser 127 (shown in FIG. 5 and described in greater detail below) configured to apply a predetermined amount of material to the ceramic core 100, which in one form is a liquid polymeric resin. Possible materials include, for example, silicone, polyurethane, polyester, and epoxies. In one form, the material is UV curable.

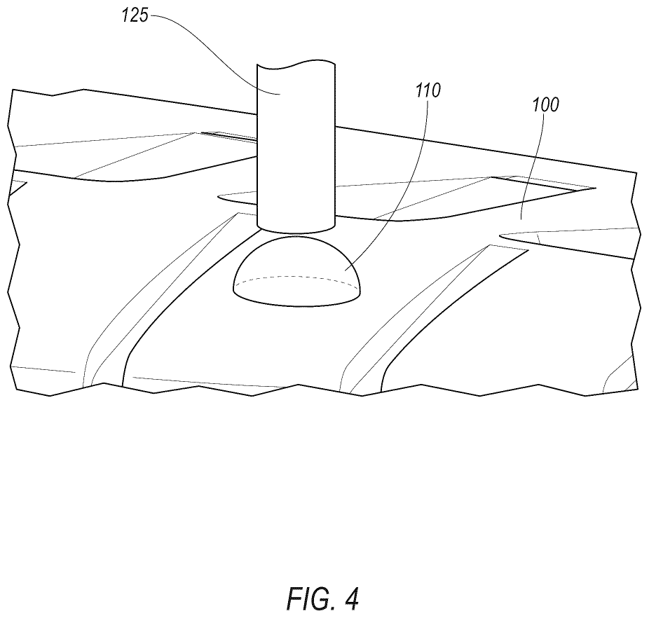

Referring to FIG. 4, the predetermined amount of material dispensed onto the ceramic core 100 at a particular location depends on the size of a desired chaplet 110 to be formed on the ceramic core 100. The size of the chaplet 110 at the particular location, particularly the height of the chaplet 110 as measured from an exterior surface of the ceramic core 100 depends on the desired wall thickness to the ceramic core 100. A volume to height ratio will depend on the specific material dispensed and the composition and surface treatment of the ceramic core. For example, if a chaplet 110 having a height of 0.025 inches is specified, a volume of 0.0018 mL polymeric resin is applied. In one form, the microdispenser 127 dispenses material at a known volumetric rate, allowing the microdispenser 127 to be controlled as a function of time. In one form, the microdispenser 127 dispenses polymeric resin at a volumetric rate of 0.12-0.5 ml/min.

Referring to FIGS. 5 to 9, a method of preparing a ceramic core 100 for wax injection by using a robotic end effector 122 according to one form of the present disclosure is now described in greater detail.

First, as shown in FIG. 5, the ceramic core 100 is held by the robotic end effector 122 and moved to the application station 125, and more specifically towards the machine applicator 124. The ceramic core 100 is then positioned under the machine applicator 124. In one form, the machine applicator 124 includes an indexing tool 123, and the microdispenser 127 and the indexing tool 123 are mounted to the same application station 125 as shown. The indexing tool 123 has a known three-dimensional location relative to the microdispenser 127 and is used to enable the microdispenser 127 to place the predetermined amount of material at the predetermined location on the ceramic core 100. In one form, the indexing tool 123 is a low-contact touch sensor, but may also be an optical sensor (not shown), among other position indicators.

The predetermined 3D location in one form is a predetermined location relative to the ceramic core 100. In another form, the predetermined 3D location may be a predetermined location relative to a reference location at the machine applicator 124 (at the dispensing step) or a reference location at the securing station 126 (at the securing/curing step). At the predetermined 3D location, the ceramic core 100 is positioned such that the microdispenser 127 can be placed in a direction normal (perpendicular) to the exterior surface of the ceramic core 100 at the predetermined location.

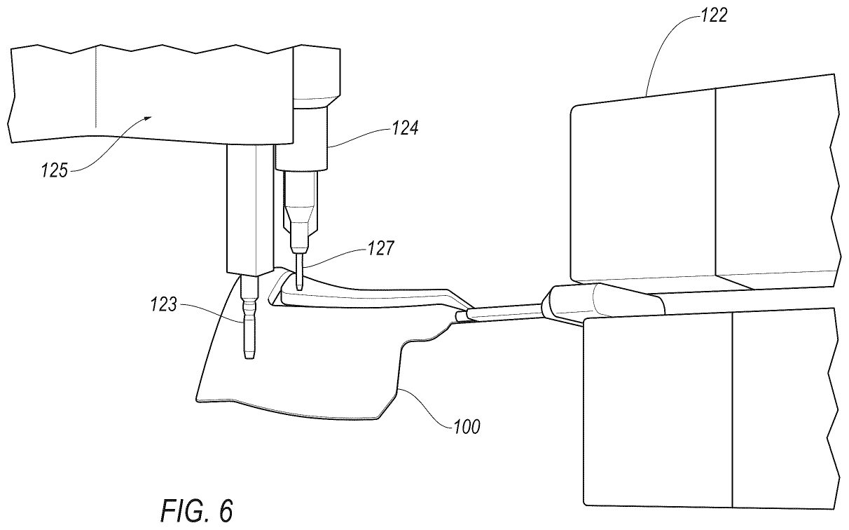

Turning to FIG. 6, when the ceramic core 100 is disposed below the machine applicator 124 at the predetermined 3D location with the microdispenser 127 placed normal to the exterior surface of the ceramic core 100, the predetermined amount of material is applied to the ceramic core 100. As set forth above, the predetermined amount of material to be dispensed on the ceramic core 100 at the particular 3D location depends on the size of the chaplet 110 to be formed. Because the microdispenser 127 is perpendicular to the surface of the ceramic core 100, the predetermined amount of material generally spreads evenly to form a dome or hemisphere (FIG. 4) at the predetermined location. In one form, the tip of the microdispenser 127 is located 1.0-1.5 times the height of the chaplet 110 for application of the predetermined amount of material.

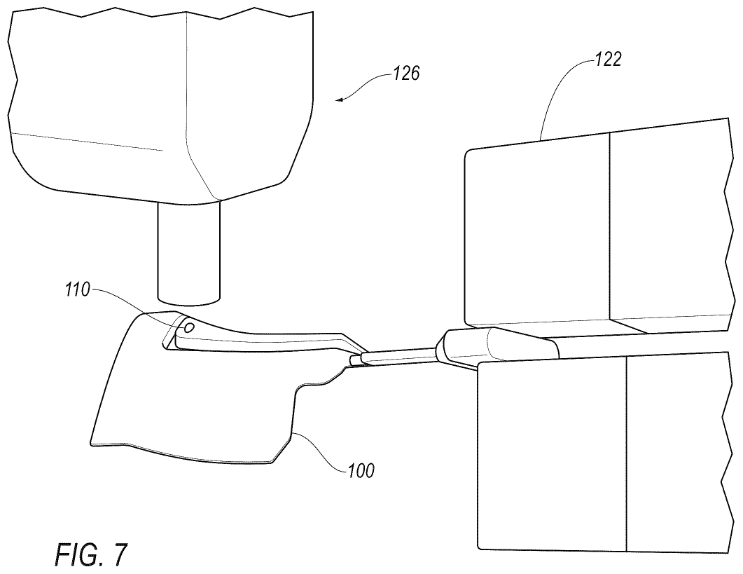

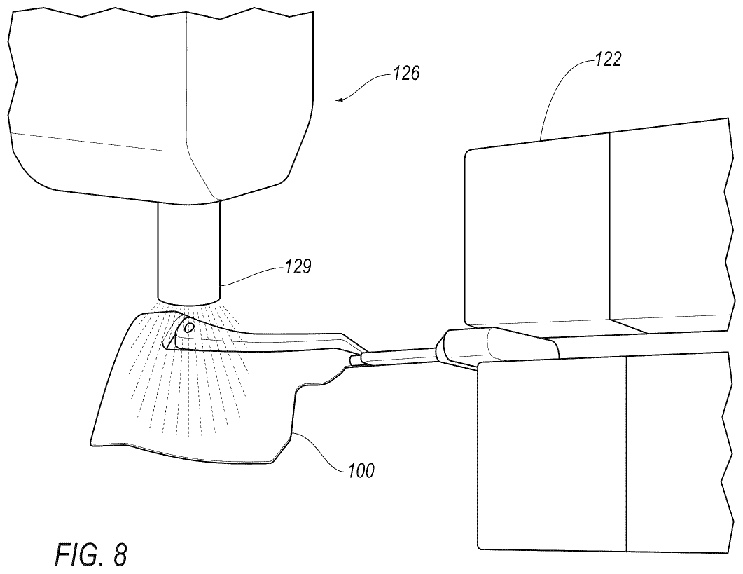

Referring to FIGS. 7 and 8, after the predetermined amount of material is dispensed onto the ceramic core 100 at the predetermined 3D locations, the ceramic core 100 is moved by the robotic end effector 122 to the securing station 126. In one form, the securing station 126 may include an ultraviolet (UV) light source 129 (FIG. 8) that cures the polymeric resin, or predetermined amounts of material, to form chaplets 110 at the predetermined 3D locations. In variations of this form, the polymeric resin may be cured by heat, electron beam, laser, or ambient conditions, among others. Thus, the UV light source 129 should not be construed as limiting the scope of the present disclosure. In one form, the polymeric resin is cured for between 2 and 3 seconds to form a chaplet 110 at a particular predetermined 3D location on the ceramic core 100. Further, it should be understood that the securing station 126, and more particularly the UV light source 129, may be integrated into the same machine applicator 124 mount without being its own separate securing station 126.

Referring back to FIG. 3, optionally, the vision system 128 is configured to verify at least one of the predetermined three-dimensional (3D) locations of the ceramic core 100 under the machine applicator 124 before the dispensing step or the predetermined locations of the predetermined amount of material on the ceramic core 100 during and after the dispensing step. The vision system 128 is in communication with the controller 130 to effect its instructions. The vision system 128 in one form includes a camera (not shown). The vision system 128 is thus generally used to verify that the chaplet 110 was formed correctly and in the correct location.

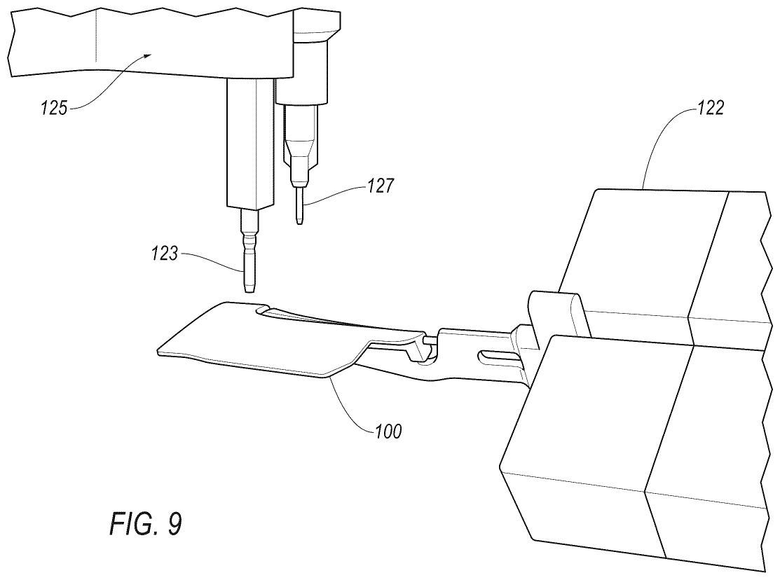

Finally, as shown in FIG. 9, after the polymeric resin is cured to form one of the chaplets 110 on the ceramic core 100, the ceramic core 100 is moved to a different 3D location at the application station 125 by the robotic end effector 122 to form another chaplet 110 at a different location on the ceramic core 100. The steps described in FIG. 5 to FIG. 8 are repeated until all the required chaplets 110 have been formed on the ceramic core 100 to form the core assembly 10 for the investment casting process.

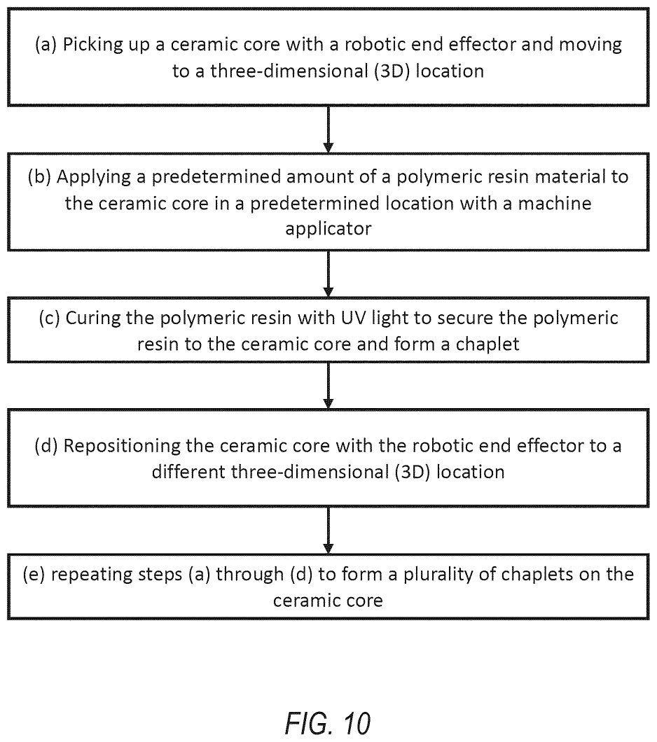

Referring to FIG. 10, the method illustrated by FIGS. 5-9 and described above is shown. The method includes: (a) picking up a ceramic core 100 with a robotic end effector 122 and moving the ceramic core 100 to a three-dimensional (3D) location; (b) applying a predetermined amount of a polymeric resin material to the ceramic core 100 in a predetermined location with a machine applicator 124; (c) curing the polymeric resin with a UV light to secure the polymeric resin to the ceramic core 100 and form a chaplet 110 on the ceramic core 100; (d) repositioning the ceramic core 100 with the robotic end effector 122 to a different three-dimensional (3D) location; and (e) repeating steps (a) through (d) to form a plurality of chaplets 110 on the ceramic core 100 to form the core assembly 10.

The process described above is merely exemplary of one form of a method of the present disclosure. In another form method, the robotic end effector 122 holds the ceramic core 100 at a single location while the machine applicator 124 and the securing station 126 move around the ceramic core 100 to form the plurality of chaplets 110 on the ceramic core 100 to form the core assembly 10. These and other variations to effect applying and securing the chaplets 110 using machine automation should be construed as falling within the scope of the present disclosure.

### Preformed Chaplet Method #2

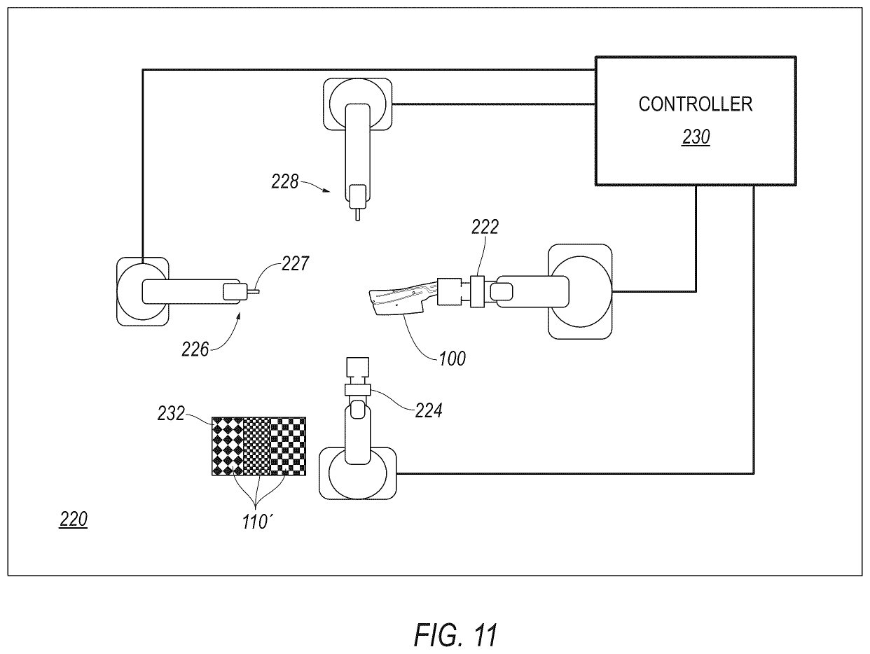

Referring to FIG. 11, according to another form of the present disclosure, the method of FIG. 2 is performed by a system 220 including a robotic end effector 222, a machine applicator 224, a securing station 226, a vision system 228, and a controller 230. The robotic end effector 222 generally grasps and moves the ceramic core 100 between the securing station 226, the machine applicator 224, and the vision system 228. As in the previous method, the controller 230 controls the robotic end effector 222 and also activates each of the machine applicator 224, the securing station 226, and the vision system 228 based on the position of the robotic end effector 222.

In this form, a plurality of chaplets 110′ are preformed and are secured to the ceramic core 100 with an adhesive material, as opposed to the chaplets 110 formed by the method described in FIGS. 5 to 10, where the chaplets 110 are formed in situ by dispensing and curing a predetermined amount of material on the ceramic core 100. In this form, the machine applicator 224 is a second robotic end effector 224 that picks up the preformed chaplets 110′ and moves the chaplets 110′ one by one to a each of a plurality of predetermined locations on the ceramic core 100.

As shown, the plurality of chaplets 110′ are provided in a bin 232 accessible to the robotic end effector 224 and each of the chaplets 110′ may have different shapes and/or sizes. The plurality of chaplets 110′ are generally separated within the bin 232 by size and shape. The plurality of chaplets 110′ are placed at a plurality of predetermined locations as needed to create the correct wall thickness at each location, as described above. In one form, the plurality of chaplets 110′ may be color coded as a function of their sizes and/or shapes. For example, a large chaplet may be red, a medium chaplet yellow, and a small chaplet green. In one form, the preformed chaplet 110′ is molded from a polymeric material, (i.e., a molded polymer), which is generally a thermoplastic material. The preformed chaplet 110′ could alternatively be printed by additive manufacturing. Further, the preformed chaplet 110′ could be made of other materials which serve the need to maintain the wall thickness within a die during wax injection. In one form, the preformed chaplet 110′ is a conical shape, but other shapes such as a dome or pyramid shape could also be utilized, among others.

The securing station 226 includes an adhesive applicator 227 which applies a predetermined amount of adhesive material to the ceramic core 100 at a predetermined location. The predetermined amount of adhesive material is generally a volume sufficient to secure the preformed chaplet 110′ to the ceramic core 100.

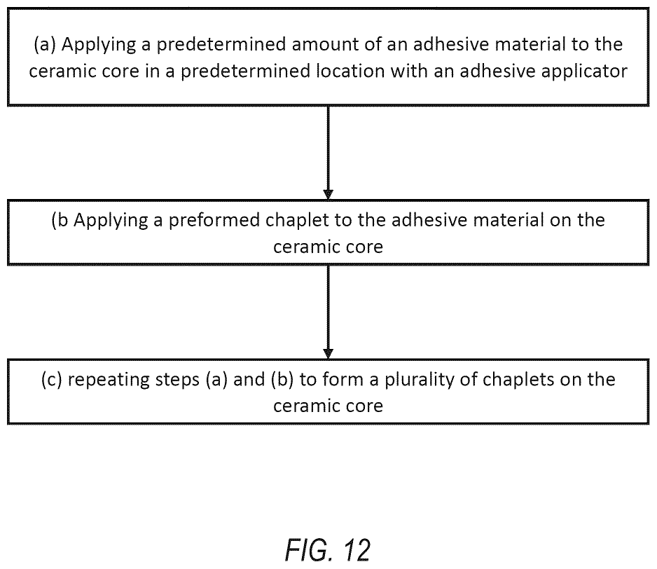

Referring now to FIG. 12, according to this second method of the present disclosure, the ceramic core 100 is first moved to a three-dimensional (3D) location at the securing station 226 with the adhesive applicator 227. A predetermined amount of adhesive material is applied to the ceramic core 100 by the adhesive applicator 227 at the predetermined location. Next, the robotic end effector 224 picks up a preformed chaplet 110′ from the bin 232 and moves the preformed chaplet 110′ to the predetermined location. Then, the robotic end effector 224 applies the preformed chaplet 110′ to the adhesive material that has been applied on the ceramic core 100. Optionally, the vision system 228 may verify the correct preformed chaplet 110′ has been applied to the correct location on the ceramic core 100 (as described above with reference to the resin cured chaplets). The robotic end effector 222 then repositions the ceramic core 100 to a different 3D location to repeat the process until all of the chaplets 110′ are bonded or secured to the ceramic core 100 to form the core assembly 10.

In a variation on this form, the ceramic core 100 is held stationary and the adhesive applicator 227 and the preformed chaplet 110′ are moved to the ceramic core 100 rather than the ceramic core 100 being moved among the various stations.

In another variation on this form, after placing each of the preformed chaplets 110′ on the adhesive, the adhesive is cured with UV light or other curing methods to further secure the chaplet 110′ to the ceramic core 100 before another chaplet 110′ is placed and bonded on the ceramic core 100.

It should be understood that the location of various stations and the movement of the ceramic core 100 or the robotic end effectors 122, 222, and 224 may be implemented in any number of combinations while remaining within the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of preparing a ceramic core for wax injection in an investment casting process, the method comprising:
(a) applying a predetermined amount of material to the ceramic core in a predetermined location with a machine applicator;
(b) securing the predetermined amount of material to the ceramic core to form a chaplet; and
(c) repeating steps (a) and (b) to form a plurality of chaplets on the ceramic core.

2. The method according to claim 1, wherein the machine applicator includes a microdispenser and the predetermined amount of material is a polymeric resin.

3. The method according to claim 2, wherein the securing in step (b) comprises curing the polymeric resin.

4. The method according to claim 3, wherein the polymeric resin is cured by ultraviolet (UV) light.

5. The method according to claim 2, wherein the microdispenser applies the polymeric resin to the ceramic core in a direction normal to an exterior surface of the ceramic core at the predetermined location.

6. The method according to claim 1, wherein the ceramic core is picked by a robotic end effector and moved to a three-dimensional (3D) location for the applying in step (a).

7. The method according to claim 6, wherein the ceramic core is repositioned to a different 3D location by the robotic end effector after step (a) and for the securing in step (b).

8. The method according to claim 7, wherein the robotic end effector repositions the ceramic core to another different 3D location for another applying in step (a).

9. The method according to claim 6, wherein the 3D location of the ceramic core is verified with a vision system.

10. The method according to claim 1, wherein a position of at least one of the plurality of chaplets on the ceramic core after step (b) is verified with a vision system.

11. The method according to claim 1, wherein the predetermined amount of material is a preformed chaplet and the machine applicator includes a robotic end effector that picks the preformed chaplet and moves the preformed chaplet to the predetermined location.

12. The method according to claim 11, wherein the preformed chaplet is a molded polymer.

13. The method according to claim 11, wherein the preformed chaplet is color coded as a function of its size.

14. The method according to claim 11, wherein a predetermined amount of adhesive is applied to the ceramic core before the robotic end effector moves the preformed chaplet to the predetermined location.

15. A system for preparing a ceramic core for wax injection in an investment casting process, the system comprising:
a robotic end effector configured to pick a ceramic core and move the ceramic core to a plurality of predetermined three-dimensional (3D) locations;
a machine applicator configured to apply a predetermined amount of material to the ceramic core in predetermined locations;
a securing station configured to secure the predetermined amount of material to the ceramic core; and
a controller comprising:
a processor; and
a non-transitory computer-readable medium including instructions that are executable by the processor, wherein the instructions include:
where and when to move the robotic end effector;
when to activate the machine applicator; and
when to activate the securing station.

16. The system according to claim 15, further comprising a vision system configured to verify at least one of the plurality of predetermined three-dimensional (3D) locations of the ceramic core or the predetermined locations of the predetermined amount of material, wherein the vision system is in communication with the controller to effect the instructions.

17. The system according to claim 15, wherein the machine applicator includes a microdispenser, and the predetermined amount of material is a polymeric resin.

18. The system according to claim 17, wherein the securing station is an ultraviolet (UV) light source that cures the polymeric resin.

19. The system according to claim 18, wherein the microdispenser and the UV light source are integrated onto a single mount.

20. The system according to claim 15, wherein the machine applicator is a robotic end effector that picks a preformed chaplet and moves the preformed chaplet to one of the predetermined locations.

21. The system according to claim 20, wherein the securing station is an adhesive applied to the ceramic core by an adhesive applicator at the predetermined locations, wherein the robotic end effector places the preformed chaplet onto the adhesive.
